(19) United States
(12) Patent Application Publication
(10) Pub. No.: US 2026/0237543 A1
(43) Pub. Date: Aug. 13, 2026

(54) INTEGRALLY FORMED INDUCTOR AND ITS MANUFACTURING METHOD FOR THE SAME

(71) Applicant: HONG DANG Technology Co., Ltd., New Taipei City (TW)

(72) Inventor: Shun-Fa CHUANG, New Taipei City (TW)

(21) Appl. No.: 19/206,587

(22) Filed: May 13, 2025

(30) Foreign Application Priority Data
Feb. 10, 2025 (TW) 114104918

(51) Int. Cl. H01F 1/057; H01F 1/058; H01F 27/26

(52) U.S. Cl. CPC H01F 1/0571; H01F 1/058; H01F 27/266

(57) ABSTRACT

An integrally formed inductor has a core column, a coil, a residual magnetic body, and magnetic sheets. The core column and the magnetic sheets are made of a composite material composed of iron-based alloys. The coil is wound around the core column and is secured by bending to form bottom electrodes at the base of the magnetic sheets. The residual magnetic body is made of a mixed powder composed of iron-based alloys, iron-based amorphous nanocrystals, and carbonyl iron powder and disposed around the core column and coil. An insulating anti-rust layer is attached to the outer surface of the residual magnetic body and is made of a material composed of phenoxy resin, phenolic epoxy resin, and silicon micro powders.

### CROSS-REFERENCE TO RELATED APPLICATIONS

This application is based upon and claims priority under 35 U.S.C. 119 from Taiwan Patent Application No. 114104918 filed on Feb. 10, 2025, which is hereby specifically incorporated herein by this reference thereto.

### BACKGROUND OF THE INVENTION

### 1. Field of the Invention

The present invention relates to an inductor, and more particularly to an integrally formed inductor and a manufacturing method for the same.

### 2. Description of the Prior Arts

Because the entire electronic equipment industry has continuously increasing requirements for energy conservation and environmental protection, improving power supply efficiency is a key development direction. High-efficiency power supplies can reduce energy losses, lower equipment operating costs, and reduce heat generation. One of the largest sources of loss in the power supply is the inductor. The conventional mainstream high-current circuit inductor is an integrated inductor made of alloy composite materials. However, because a coil needs to be pressed together with a magnet, which causes the deformation of a coil and increases the resistance of the coil. At the same time, the coil is subjected to significant stress due to compression and deformation, the loss is high and a risk of short circuit still exists.

Therefore, the development of new high-frequency, high-current, low-loss composite materials and their integrated inductor technology are necessary for the composition, process design and structural design of the alloy powders for the conventional integrally formed inductor to improve the use of materials for maintaining low losses at high frequencies and high power

To overcome the shortcomings, the present invention provides an integrally formed inductor to mitigate or to obviate the aforementioned problems.

### SUMMARY

The present invention provides an integrally formed inductor has
a core column made of a composite material composed of iron-based alloy, wherein the iron-base alloy comprises silicon (Si), aluminum (Al), and chromium (Cr);
a coil wound around the core column; and
a magnetic sheet made of the composite material composed of iron-based alloy and mounted on a bottom of the core column, wherein the coil is secured by bending to form a bottom electrode at a bottom of the magnetic sheet; and
a residual magnetic body mounted around the core column and the coil and made of mixed powders composed of iron-based alloy, iron-based amorphous nanocrystals, and carbonyl iron powders, wherein the bottom electrode is exposed from the residual magnetic body; and
an insulating anti-rust layer attached to an outer surface of the residual magnetic body and made of a material composed of phenoxy resin, phenolic epoxy resin, and silicon micro powders.

Furthermore, the present invention also provides a manufacturing method for making the inductor has steps of providing the core column, winding the coil around the core column, attaching the magnetic sheet onto the bottom of the core column, and bending the coil and securing the coil on the bottom of the magnetic sheet to form the bottom electrode at the bottom of the magnetic sheet, wherein the core column, the coil, and the bottom electrode are formed as a winding, disposing the residual magnetic body around the winding, and disposing the insulating anti-rust layer around the residual magnetic body.

The advantages of the present invention are the following: the silicon (Si) in the core column material forms an internal insulating layer within the metal crystal structure, and internal eddy currents are reduced. Additionally, the surfaces of material particles become enriched with an insulating layer composed of aluminum (Al) and chromium (Cr), so eddy currents are further reduced. The high iron (Fe) content maintains a high magnetic permeability to allow the use of coils with lower resistance to achieve the same inductance value, thereby reducing inductance loss. Moreover, the residual magnetic body made of a combination of nanocrystals and ultrafine alloys further minimizes high-frequency eddy current losses, such that inductor losses is reduced and the power conversion efficiency of circuits utilizing this inductor is improved.

### BRIEF DESCRIPTION OF THE DRAWINGS

FIG. 1 is a perspective view of an integrally formed inductor in accordance with the present invention;

FIG. 2 is an enlarged perspective view of a winding of the inductor in FIG. 1;

FIG. 3 is another perspective view of the winding in FIG. 2;

FIG. 4 is a cross sectional front view of the inductor in FIG. 1; and

FIG. 5 is a block diagram of a manufacturing method for making an integrally formed inductor in accordance with the present invention.

### DETAILED DESCRIPTION OF THE EMBODIMENTS

The present invention is related to an improved charging connector. Other objectives, advantages, and novel features of the invention will become more apparent from the detailed description in conjunction with the accompanying drawings.

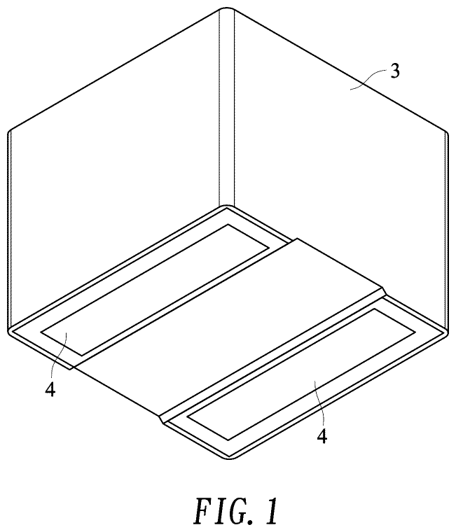

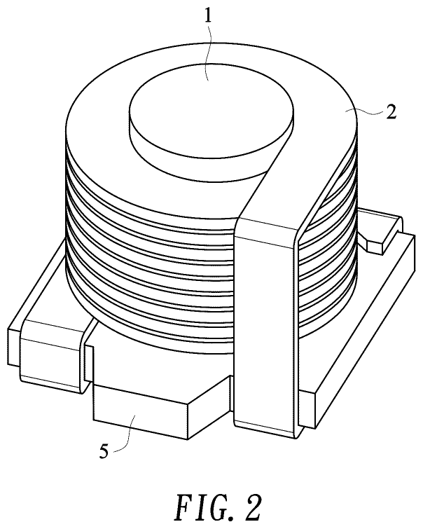

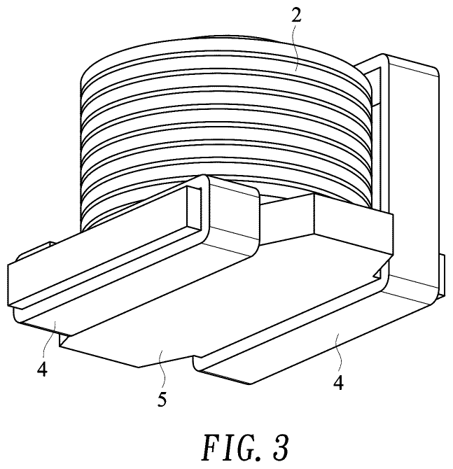

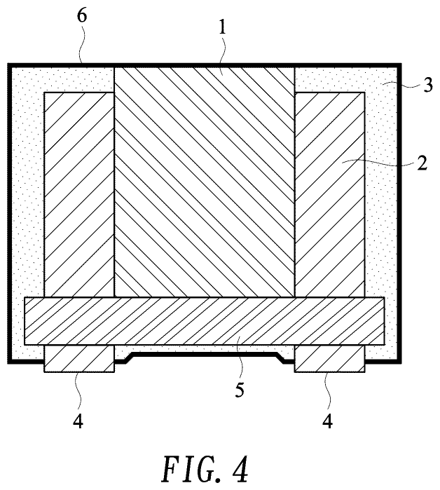

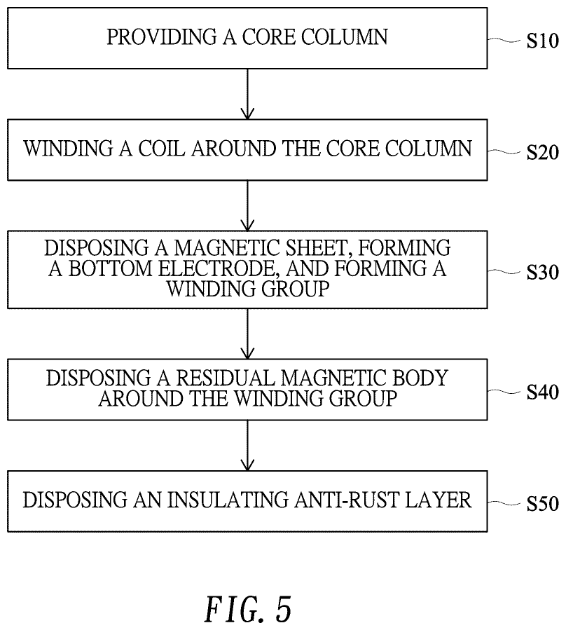

With reference to FIGS. 1 to 5, a manufacturing method for making an integrally formed inductor in accordance with the present invention comprises steps of: providing a core column 1 (S10), winding a coil 2 around the core column 1 (S20), attaching a magnetic sheet 5 onto a bottom of the core column 1, and bending the coil 2 and securing the coil 2 on a bottom of the magnetic sheet 5 to form a bottom electrode 4 at the bottom of the magnetic sheet 5 (S30), wherein the core column 1, the coil 2, and the bottom electrode 4 of the coil 2 are formed as a winding, disposing a residual magnetic body 3 around the winding and making the bottom electrode be exposed from the residual magnetic body 3 (S40), and disposing an insulating anti-rust layer 6 around the residual magnetic body 3 (S50). In one embodiment, step S40 involves placing the winding together with the powder that constitutes the residual magnet body 3 into a mold, so that the powder of the residual magnet body 3 envelops the winding while exposing the bottom electrode 4. The powder is then hot-pressed within the mold to form the residual magnet 3, thereby molding it to cover the exterior of the winding. The core column 1 has a volume of 20 vol %~50 vol % of a volume of the residual magnetic body 3 and the space surrounding by the magnetic body 3. The core column 1 and the magnetic sheet 5 are made of a composite material composed of iron (Fe)-based alloy, which is composed of 92.1-96.43 wt % of iron (Fe), 3.5~7.5 wt % of silicon (Si), 0.01~0.1 wt % of boron (B), 0.01~0.1 wt % of aluminum (Al), and 0.05~0.2 wt % of chromium (Cr). The composite material composed of iron (Fe) has a particle size of 5 to 53 um. An outer surface of each particle of the composite material has a 10 to 10 nm composite oxide layer of silicon oxide, iron oxide, and chromium oxide. A height of the core column 1 is 60 to 90% of a height of the inductor. The residual magnetic body 3 is made of mixed powders composed of iron-based alloy, iron-based amorphous nanocrystals, and carbonyl iron powders. The mixed powders comprises a main material composed of 89.7~94.97 wt % of Fe, 3.0~5.5 wt % of Si, 2.0~4.5 wt % of B, 0.01~0.1 wt % of phosphorus (P), 0.01~0.1 wt % of copper (Cu), and 0.01~0.1 wt % of nickel (Ni) and the iron-based alloy with a particle size of 3 um to 5 um. The nanocrystalline material has a weight of 60 wt %~80 wt % of a weight of the mixed powders, wherein the iron-based alloy has a weight of 20 wt %~40 wt % of a weight of the mixed powders. In one embodiment, the core column 1 and the magnetic sheet 5 are formed by mixing their respective material powders with a binder and a solvent to prepare a slurry. The slurry is then injected into corresponding molds to form green bodies, which are subsequently dried at a specified temperature for a predetermined period to remove the solvent and further cure the structures, thereby forming the core column 1 and the magnetic sheet 5. Each nanocrystalline material has two coating layers on an outer surface of the nanocrystalline material including a first layer and a second layer. The first layer is made of a mixed material composed of oxides, including aluminum oxide, silicon oxide, and chromium oxide, and has a thickness of 8 to 15 nm. The second layer is a mixed layer made of organic resins composed of epoxy resin and silicon resin. The epoxy resin has a softening temperature lower than 100° C. The silicon resin has a thermal decomposition temperature higher than 300° C. The two coating layers have a thickness between 100 to 200 nm. The mass ratio of the epoxy resin and the silicon resin is 1:1 to 3:1. The iron-based alloy has a coating layer on an outer surface of the iron-based alloy and having a thickness between 50 to 150 nm. The coating layer of the iron-based alloy is made of a mix composed of phenolic resin and silicon resin. The phenolic resin has a softening temperature lower than 100° C. The silicon resin has a thermal decomposition temperature higher than 300° C. A mass ratio of the phenolic resin and the silicon resin is 1:1 to 3:1. The insulating anti-rust layer is formed on the surface of the residual magnetic body 3, and the insulating anti-rust layer 6 has a thickness between 10 to 30 um. The insulating anti-rust layer 6 is made of a material composed of phenoxy resin, phenolic epoxy resin, and silicon micro powders. The phenoxy resin has a weight of 50 wt %~80 wt % of a weight of the insulating anti-rust layer 6. The phenoxy resin has a molecular weight greater than 8000. The phenolic resin has a weight of 10 wt %~30 wt % of a weight of the insulating anti-rust layer and has a glass transition temperature higher than 150° C. The silicon micro powders have a weight of 10 wt %~20 wt % of a weight of the insulating anti-rust layer 6, and each silicon micro powder has a particle size of 8 to 20 um.

The silicon (Si) in the core column material forms an internal insulating layer within the metal crystal structure, and internal eddy currents are reduced. Additionally, the surfaces of material particles become enriched with an insulating layer composed of aluminum (Al) and chromium (Cr), so eddy currents are further reduced. The high iron (Fe) content maintains a high magnetic permeability to allow the use of coils with lower resistance to achieve the same inductance value, thereby reducing inductance loss. Moreover, the residual magnetic body made of a combination of nanocrystals and ultrafine alloys further minimizes high-frequency eddy current losses, such that inductor losses is reduced and the power conversion efficiency of circuits utilizing this inductor is improved.

The following will clearly and completely describe the technique of the present invention with some embodiments, the following embodiments are not all of the embodiments of the present invention.

### Embodiment 1

The integrally formed inductor in accordance with the present invention comprises a core column 1, a coil 2, a residual magnetic body 3, and a magnetic sheet 5. The coil 2 is wound around the core column 1 and is secured by bending to form a bottom electrode 4 at a bottom of the magnetic sheet 5. The core column 1 has a volume of 50 vol % of a volume of the residual magnetic body 3. The core column 1 and the magnetic sheet 5 are made of a composite material composed of iron-based alloy, which is composed of 92.1 wt % of Fe, 7.5 wt % of Si, 0.1 wt % of B, 0.1 wt % of Al, and 0.2 wt % of Cr and has a particle size of 5 to 53 um. The outer surface of each particle has a 10 nm composite oxide layer of silicon oxide, iron oxide, and chromium oxide. The height of the core column 1 is 90% of a height of the inductor. The material for the residual magnetic body 3 comprises the main material composed of 94.97 wt % of Fe, 3.0 wt % of Si, 2.0 wt % of B, 0.01 wt % of P, 0.01 wt % of Cu, and 0.01 wt % of Ni and 5 um of iron-based alloy. The iron-based alloy is composed of 94.97 wt % of Fe, 3.5 wt % of Si, 0.01 wt % of B, and 0.01 wt % of P. The nanocrystalline material has a weight of 60 wt % of a weight of the mixed powders. The iron-based alloy has a weight of 40 wt % of the weight of the mixed powders. Each nanocrystalline material has two coating layers on an outer surface of the nanocrystalline material including a first layer and a second layer. The first layer is made of a mixed material composed of oxides, including aluminum oxide and silicon oxide, and has a thickness of 15 nm. The second layer is a mixed layer made of organic resins composed of epoxy resin and silicon resin. The epoxy resin has a softening temperature being 70° C. The silicon resin has a thermal decomposition temperature being 330° C. The two coating layers have a thickness of 100 nm. The mass ratio of the epoxy resin and the silicon resin is 1:1. The iron-based alloy has a coating layer on an outer surface of the iron-based alloy and having a thickness of 50 nm. The coating layer of the iron-based alloy is made of a mix composed of phenolic resin and silicon resin. The phenolic resin has a softening temperature being 80° C. The silicon resin has a thermal decomposition temperature being 330° C. A mass ratio of the phenolic resin and the silicon resin is 1:1. The insulating anti-rust layer 6 is formed on the surface of the inductor, and the insulating anti-rust layer 6 has a thickness of 30 um. The insulating anti-rust layer 6 is made of a material composed of phenoxy resin, phenolic epoxy resin, and silicon micro powders. The phenoxy resin has a weight of 50 wt % of a weight of the insulating anti-rust layer 6. The phenoxy resin has a molecular weight being 8700. The phenolic resin has a weight of 30 wt % of a weight of the insulating anti-rust layer and has a glass transition temperature of 160° C. The silicon micro powders have a weight of 20 wt % of a weight of the insulating anti-rust layer 6, and each silicon micro powder has a particle size of 20 um.

### Embodiment 2

The integrally formed inductor in accordance with the present invention comprises a core column 1, a coil 2, a residual magnetic body 3, and a magnetic sheet 5. The coil 2 is wound around the core column 1 and is secured by bending to form a bottom electrode 4 at a bottom of the magnetic sheet 5. The core column 1 has a volume of 20 vol % of a volume of the residual magnetic body 3. The core column 1 and the magnetic sheet 5 are made of a composite material composed of iron-based alloy, which is composed of 96.43 wt % of Fe, 3.5 wt % of Si, 0.01 wt % of B, 0.01 wt % of Al, and 0.05 wt % of Cr and has a particle size of 5 to 53 um. The outer surface of each particle has a 100 nm composite oxide layer of silicon oxide, iron oxide, and chromium oxide. The height of the core column 1 is 60% of a height of the inductor. The material for the residual magnetic body 3 comprises the main material composed of 89.7 wt % of Fe, 5.5 wt % of Si, 4.5 wt % of B, 0.1 wt % of P, 0.1 wt % of Cu, and 0.1 wt % of Ni and 3 um of iron-based alloy. The iron-based alloy is composed of 92.1 wt % of Fe, 7.5 wt % of Si, 0.1 wt % of B, and 0.1 wt % of P. The nanocrystals has a weight of 80 wt % of a weight of the mixed powders. The iron-based alloy has a weight of 20 wt % of the weight of the mixed powders. Each nanocrystalline material has two coating layers on an outer surface of the nanocrystalline material and including a first layer and a second layer. The first layer is made of a mixed material composed of oxides, including aluminum oxide and silicon oxide, and has a thickness of 8 nm. The second layer is a mixed layer made of organic resins composed of epoxy resin and silicon resin. The epoxy resin has a softening temperature being 60° C. The silicon resin has a thermal decomposition temperature being 360° C. The two coating layers have a thickness of 200 nm. The mass ratio of the epoxy resin and the silicon resin is 3:1. The iron-based alloy has a coating layer on an outer surface of the iron-based alloy and having a thickness of 150 nm. The coating layer of the iron-based alloy is made of a mix composed of phenolic resin and silicon resin. The phenolic resin has a softening temperature being 65° C. The silicon resin has a thermal decomposition temperature being 360° C. A mass ratio of the phenolic resin and the silicon resin is 3:1. The insulating anti-rust layer 6 is formed on the surface of the inductor, and the insulating anti-rust layer 6 has a thickness of 30 um. The insulating anti-rust layer 6 is made of a material composed of phenoxy resin, phenolic epoxy resin, and silicon micro powders. The phenoxy resin has a weight of 80 wt % of a weight of the insulating anti-rust layer 6. The phenoxy resin has a molecular weight being 9000. The phenolic resin has a weight of 10 wt % of a weight of the insulating anti-rust layer and has a glass transition temperature being 170° C. The silicon micro powders have a weight of 10 wt % of a weight of the insulating anti-rust layer 6, and each silicon micro powder has a particle size of 8 um.

### Embodiment 3

The integrally formed inductor in accordance with the present invention comprises a core column 1, a coil 2, a residual magnetic body 3, and a magnetic sheet 5. The coil 2 is wound around the core column 1 and is secured by bending to form a bottom electrode 4 at a bottom of the magnetic sheet 5. The core column 1 has a volume of 20 vol % to 50 vol % of a volume of the residual magnetic body 3. The core column 1 and the magnetic sheet 5 are made of a composite material composed of iron-based alloy, which is composed of 94.35 wt % of Fe, 5.5 wt % of Si, 0.05 wt % of B, 0.05 wt % of Al, and 0.15 wt % of Cr and has a particle size of 5 to 53 um. The outer surface of each particle has a 50 nm composite oxide layer of silicon oxide, iron oxide, and chromium oxide. The height of the core column 1 is 75% of a height of the inductor. The material for the residual magnetic body 3 comprises the main material composed of 91.75 wt % of Fe, 4.7 wt % of Si, 3.4 wt % of B, 0.05 wt % of P, 0.05 wt % of Cu, and 0.05 wt % of Ni and 4 um of iron-based alloy. The iron-based alloy is composed of 93.8 wt % of Fe, 6.1 wt % of Si, 0.05 wt % of B, and 0.05 wt % of P. The nanocrystalline material has a weight of 70 wt % of a weight of the mixed powders. The iron-based alloy has a weight of 30 wt % of the weight of the mixed powders. Each nanocrystalline material has two coating layers on an outer surface of the nanocrystalline material including a first layer and a second layer. The first layer is made of a mixed material composed of oxides, including aluminum oxide and silicon oxide, and has a thickness of 12 nm. The second layer is a mixed layer made of organic resins composed of epoxy resin and silicon resin. The epoxy resin has a softening temperature being 80° C. The silicon resin has a thermal decomposition temperature being 370° C. The two coating layers have a thickness of 150 nm. The mass ratio of the epoxy resin and the silicon resin is 2:1. The iron-based alloy has a coating layer on an outer surface of the iron-based alloy and having a thickness of 90 nm. The coating layer of the iron-based alloy is made of a mix composed of phenolic resin and silicon resin. The phenolic resin has a softening temperature being 80° C. The silicon resin has a thermal decomposition temperature being 370° C. A mass ratio of the phenolic resin and the silicon resin is 2:1. The insulating anti-rust layer 6 is formed on the surface of the inductor, and the insulating anti-rust layer 6 has a thickness of 20 um. The insulating anti-rust layer 6 is made of a material composed of phenoxy resin, phenolic epoxy resin, and silicon micro powders. The phenoxy resin has a weight of 70 wt % of a weight of the insulating anti-rust layer 6. The phenoxy resin has a molecular weight being 9000. The phenolic resin has a weight of 15 wt % of a weight of the insulating anti-rust layer and has a glass transition temperature of 170° C. The silicon micro powders have a weight of 15 wt % of a weight of the insulating anti-rust layer 6, and each silicon micro powder has a particle size of 12 um.

### Comparison Example 1

The integrally formed inductor in accordance with the present invention comprises a core column 1, a coil 2, a residual magnetic body 3, and a magnetic sheet 5. The coil 2 is wound around the core column 1 and is secured by bending to form a bottom electrode 4 at a bottom of the magnetic sheet 5. The core column 1 has a volume of 50 vol % of a volume of the residual magnetic body 3. The core column 1 and the magnetic sheet 5 are made of a composite material composed of a main material composed of 94.97 wt % of Fe, 3.0 wt % of Si, 3.0 wt % of B, 0.01 wt % of P, 0.01 wt % of Cu, and 0.015 wt % of Ni and 5 um of iron-based alloy. The iron-based alloy is composed of 96.43 wt % of Fe, 3.5 wt % of Si, 0.01 wt % of B, and 0.01 wt % of P. The nanocrystals has a weight of 60 wt % of a weight of the mixed powders. The iron-based alloy has a weight of 40 wt % of the weight of the mixed powders. Each nanocrystalline material has two coating layers on an outer surface of the nanocrystalline material including a first layer and a second layer. The first layer is made of a mixed material composed of oxides, including aluminum oxide and silicon oxide, and has a thickness of 15 nm. The second layer is a mixed layer made of organic resins composed of epoxy resin and silicon resin. The epoxy resin has a softening temperature being 70° C. The silicon resin has a thermal decomposition temperature being 330° C. The two coating layers have a thickness of 100 nm. The mass ratio of the epoxy resin and the silicon resin is 1:1. The iron-based alloy has a coating layer on an outer surface of the iron-based alloy and having a thickness of 50 nm. The coating layer of the iron-based alloy is made of a mix composed of phenolic resin and silicon resin. The phenolic resin has a softening temperature being 80° C. The silicon resin has a thermal decomposition temperature being 330° C. A mass ratio of the phenolic resin and the silicon resin is 1:1. The insulating anti-rust layer 6 is formed on the surface of the inductor, and the insulating anti-rust layer 6 has a thickness of 30 um. The insulating anti-rust layer 6 is made of a material composed of phenoxy resin, phenolic epoxy resin, and silicon micro powders. The phenoxy resin has a weight of 50 wt % of a weight of the insulating anti-rust layer 6. The phenoxy resin has a molecular weight being 8700. The phenolic resin has a weight of 30 wt % of a weight of the insulating anti-rust layer and has a glass transition temperature being 160° C. The silicon micro powders have a weight of 20 wt % of a weight of the insulating anti-rust layer 6, and each silicon micro powder has a particle size of 20 um.

To evaluate the performances of the product, which has a size of a length of 6.0 mm* a width of 6.0 mm* a height of 1.8 mm, The inductance value (1V/1 MHz) of the magnetic ring sample and the inductance value at 100 A current for each embodiment and Comparative Example 1 were measured using a 3260B-type LCR meter and a thermistor chip resistor. The losses (1 MHz/1 A) for each embodiment and Comparative Example 1 were measured using the SY8218 instrument.

TABLE 1
performance comparison between the embodiments
and the comparison example (0420 inductor)

| | | Embodi- | Embodi- | Embodi- | Comparison |
|---|---|---|---|---|---|
| Test item | unit | ment 1 | ment 2 | ment 3 | example 1 |
| L | μH | 2.21 | 2.18 | 2.2 | 1.76 |
| L1(current = | μH | 1.83 | 1.87 | 1.85 | 1.31 |
| 100A) | | | | | |
| PC(loss) | mW | 23 | 25 | 19 | 39 |

Under the same inductance, the inductor prepared in the embodiments not only have higher inductance but also have a better loss than that of the comparison example 1. Therefore, the present invention has the advantage of low power consumption in actual applications, thereby the conversion efficiency of the product application circuit is improved. The table shows that composition control and structural design are very important for low-loss inductors.

Even though numerous characteristics and advantages of the present invention have been set forth in the foregoing description, together with details of the structure and features of the invention, the disclosure is illustrative only. Changes may be made in the details, especially in matters of shape, size, and arrangement of parts within the principles of the invention to the full extent indicated by the broad general meaning of the terms in which the appended claims are expressed.

What is claimed is:

1. An inductor comprising
a core column made of a composite material composed of iron-based alloy, wherein the iron-base alloy comprises silicon (Si), aluminum (Al), and chromium (Cr);
a coil wound around the core column; and
a magnetic sheet made of the composite material composed of iron-based alloy and mounted on a bottom of the core column, wherein the coil is secured by bending to form a bottom electrode at a bottom of the magnetic sheet; and
a residual magnetic body mounted around the core column and the coil and made of mixed powders composed of iron-based alloy, iron-based amorphous nanocrystals, and carbonyl iron powders, wherein the bottom electrode is exposed from the residual magnetic body; and
an insulating anti-rust layer attached to an outer surface of the residual magnetic body and made of a material composed of phenoxy resin, phenolic epoxy resin, and silicon micro powders.

2. The inductor as claimed in claim 1, wherein the core column has a volume of 20 vol %~50 vol % of a volume of the residual magnetic body.

3. The inductor as claimed in claim 1, wherein the composite material for the core column and the magnetic sheet comprises 92.1~96.43 wt % of iron (Fe), 3.5~7.5 wt % of Si, 0.01~0.1 wt % of boron (B), 0.01~0.1 wt % of Al, and 0.05~0.2 wt % of Cr, and each material of the composite material has a particle size between 5 to 53 um, wherein an outer surface of each particle of the composite material has a 10 to 10 nm composite oxide layer of silicon oxide, iron oxide, and chromium oxide, and a height of the core column is 60 to 90% of a height of the inductor.

4. The inductor as claimed in claim 1, wherein the mixed powders for the residual magnetic body comprises a main material composed of 89.7~94.97 wt % of Fe, 3.0~5.5 wt % of Si, 2.0~4.5 wt % of B, 0.01~0.1 wt % of phosphorus (P), 0.01~0.1 wt % of copper (Cu), and 0.01~0.1 wt % of nickel (Ni) and 3 um to 5 um of iron-based alloy, wherein
the iron-based alloy composed of 92.1~96.43 wt % of Fe, 3.5~7.5 wt % of Si, 0.01~0.11 wt % of B, and 0.01~0.11 wt % of P, the nanocrystals has a weight of 60 wt %~80 wt % of a weight of the mixed powders, and each nanocrystalline material has two coating layers on an outer surface of the nanocrystalline material and including a first layer made of a mixed material composed of oxides including aluminum oxide and silicon oxide and having a thickness of 8 to 15 nm and a second layer being a mixed layer made of organic resins composed of epoxy resin and silicon resin, wherein
the epoxy resin has a softening temperature lower than 100° C.;
the silicon resin has a thermal decomposition temperature higher than 300° C.;
the two coating layers have a thickness between 100 to 200 nm; and
a mass ratio of the epoxy resin and the silicon resin is 1:1 to 3:1, wherein
the iron-based alloy has a coating layer on an outer surface of the iron-based alloy and having a thickness between 50 to 150 nm;
the coating layer of the iron-based-alloy is made of a mixed composed of phenolic resin and silicon resin;
the phenolic resin has a softening temperature lower than 100° C.;
the silicon resin has a thermal decomposition temperature higher than 300° C.; and
a mass ratio of the phenolic resin and the silicon resin is 1:1 to 3:1.

5. The inductor as claimed in claim 1, wherein the insulating anti-rust layer has a thickness between 10 to 30 um, wherein
the phenoxy resin has a weight of 50 wt %~80 wt % of a weight of the insulating anti-rust layer;
the phenoxy resin has a molecular weight greater than 8000;
the phenolic resin has a weight of 10 wt %~30 wt % of a weight of the insulating anti-rust layer;
the phenolic resin has a glass transition temperature higher than 150° C.;
the silicon micro powders have a weight of 10 wt %~20 wt % of a weight of the insulating anti-rust layer; and
each silicon micro powder has a particle size of 8 to 20 um.

6. A manufacturing method for making the inductor as claimed in claim 1, comprising steps of:
providing the core column;
winding the coil around the core column;
attaching the magnetic sheet onto the bottom of the core column, and bending the coil and securing the coil on the bottom of the magnetic sheet to form the bottom electrode at the bottom of the magnetic sheet, wherein the core column, the coil, and the bottom electrode are formed as a winding;
disposing the residual magnetic body around the winding; and
disposing the insulating anti-rust layer around the residual magnetic body.

7. The manufacturing method as claimed in claim 6, wherein in the step of disposing the residual magnetic body, the core column has a volume of 20 vol %~50 vol % of a volume of the residual magnetic body.

8. The method as claimed in claim 6, wherein in the step of providing the core column and attaching the magnetic sheet, the composite material for the core column and the magnetic sheet comprises 92.1~96.43 wt % of iron (Fe), 3.5~7.5 wt % of Si, 0.01~0.1 wt % of boron (B), 0.01~0.1 wt % of Al, and 0.05~0.2 wt % of Cr, and each material of the composite material has a particle size between 5 to 53 um, wherein an outer surface of each particle of the composite material has a 10 to 10 nm composite oxide layer of silicon oxide, iron oxide, and chromium oxide, and a height of the core column is 60 to 90% of a height of the inductor.

9. The method as claimed in claim 6, wherein in the step of disposing the residual magnetic body, the mixed powders for the residual magnetic body comprises a main material composed of 89.7~94.97 wt % of Fe, 3.0~5.5 wt % of Si, 2.0~4.5 wt % of B, 0.01~0.1 wt % of phosphorus (P), 0.01~0.1 wt % of copper (Cu), and 0.01~0.1 wt % of nickel (Ni) and 3 um to 5 um of iron-based alloy, wherein
the iron-based alloy composed of 92.1~96.43 wt % of Fe, 3.5~7.5 wt % of Si, 0.01~0.11 wt % of B, and 0.01~0.11 wt % of P, the nanocrystals has a weight of 60 wt %~80 wt % of a weight of the mixed powders, and each nanocrystalline material has two coating layers on an outer surface of the nanocrystalline material and including a first layer made of a mixed material composed of oxides including aluminum oxide and silicon oxide and having a thickness of 8 to 15 nm and a second layer being a mixed layer made of organic resins composed of epoxy resin and silicon resin, wherein
the epoxy resin has a softening temperature lower than 100° C.;
the silicon resin has a thermal decomposition temperature higher than 300° C.;
the two coating layers have a thickness between 100 to 200 nm; and
a mass ratio of the epoxy resin and the silicon resin is 1:1 to 3:1, wherein
the iron-based alloy has a coating layer on an outer surface of the iron-based alloy and having a thickness between 50 to 150 nm;
the coating layer of the iron-based-alloy is made of a mixed composed of phenolic resin and silicon resin;
the phenolic resin has a softening temperature lower than 100° C.;
the silicon resin has a thermal decomposition temperature higher than 300° C.; and
a mass ratio of the phenolic resin and the silicon resin is 1:1 to 3:1.

10. The method as claimed in claim 6, wherein in the step of disposing the insulating anti-rust layer, the insulating anti-rust layer has a thickness between 10 to 30 um, wherein
the phenoxy resin has a weight of 50 wt %~80 wt % of a weight of the insulating anti-rust layer;
the phenoxy resin has a molecular weight greater than 8000;
the phenolic resin has a weight of 10 wt %~30 wt % of a weight of the insulating anti-rust layer;
the phenolic resin has a glass transition temperature higher than 150° C.;
the silicon micro powders have a weight of 10 wt %~20 wt % of a weight of the insulating anti-rust layer; and
each silicon micro powder has a particle size of 8 to 20 um.
